(19) United States
(12) Patent Application Publication
(10) Pub. No.: US 2002/0034365 A1
(43) Pub. Date: Mar. 21, 2002

(54) Locating system for indentifying and locating subterranean optical cables

(75) Inventor: Horst Vogelsang, Herten (DE)

Correspondence Address: THE FIRM OF KARL F ROSS, 5676 RIVERDALE AVENUE, PO BOX 900, RIVERDALE (BRONX), NY, 10471-0900, US

(73) Assignee: Dipl-Ing. Dr. Ernst Vogelsang GmbH & Co. KG

(21) Appl. No.: 09/797,417

(22) Filed: Mar. 1, 2001

(30) Foreign Application Priority Data
Sep. 20, 2000 (EP) 00120519.4

(51) Int. Cl. G02B 6/44

(52) U.S. Cl. 385/100; 324/67

(57) ABSTRACT

A system for detecting the orientation of an optical cable for communication purposes has resonant networks or transponders on or in the cable jacket or sheath which have electromagnetic field lines detachable at the surface and running in the direction of the cable. The system can be used for identification of the cable as well.

### FIELD OF THE INVENTION

The present invention relates to a locating system for identifying and/or determining the orientation of subterranean cables for optical communications, especially glass fiber cables which have at least one light waveguide and a cable jacket.

BACKGROUND OF THE INVENTION

A continuing problem with subterranean cables for optical communications is their identification and a determination of their positions or orientations. This problem attaches also to cables which must be laid under water.

Usually cables for optical communication and especially glass fiber cables are received in subterranean protective conduits and are thereby isolated from the environment. After the protective conduits are installed, thereby forming long passages through the conduits, the glass fiber cable, like copper electrical cables, heretofore, are blown through the conduit or are drawn through the conduit.

Since cables for optical communications are generally not mapped as to where they are located or may be insufficiently mapped, in the case of repair, maintenance, replacement and even for connection to the cables from time to time, difficulties have been encountered in finding them. Even when a search for a cable is successful, frequently one cannot be certain as to which of a number of cables has been detected or whether or not the particular cable sought is the cable which has been found. Another problem is that the cables may be affected by earth moving equipment if there is inadequate protection.

For example, warning devices have been provided in the past for subterranean cables and conduit, e.g. in the form of a detectable signalling strip. For example, a strip of synthetic resin material having two or more metallic conductors running through the strip and associated apparatus connected to the conductors have been used to generate electrical warning signals or for detection by appropriate detector systems.

Such warning devices, however, are not fully satisfactory for identification of particular cables or for exact determinations as to the orientations and locations of the cables, especially subterranean cables for optical communications.

It is also known to equip electrically conductive cables as they are drawn into conduits with means for enabling transmitters to be galvanically or inductively coupled therewith. Such electrically conductive cables, however, cannot remain permanently energized because of the danger of electrical breakdown.

Even the use of passive resonance circuits as socalled markers which can be buried with the conduits and can then be detected with appropriate receivers has been found to be unsatisfactory. Such markers generally produce spherical electromagnetic fields without orientation. It is, therefore, difficult to follow the conduit path or determine the depth with any kind of precision. These techniques have not been found to be satisfactory at all for identifying or determining the position of subterranean cables for optical communications.

### OBJECTS OF THE INVENTION

It is the principal object of the present invention to provide a locating system whereby subterranean cables and especially glass fiber cables for optical communications can be clearly identified and by means of which their positions can be exactly determined.

Another object of this invention is to provide a system for locating subterranean optical cables from the drawbacks of earlier systems and can detect with assurance how such cables run in their subterranean lies.

### SUMMARY OF THE INVENTION

These objects and others which will become apparent hereinafter are attained, in accordance with the invention, in a locating system capable of identifying and/or determining the orientation and position of subterranean cables for optical communications, especially glass fiber communications having at least one light waveguide (optical fiber) and a cable jacket, which comprises one or more resonant circuits or transponders and a detector. According to the invention, the resonant circuits or transponders are provided on the cable jacket, i.e. on or within the jacket, and/or in connection regions of the cable strand and/or in the cable strand itself and are so oriented and constructed that the electromagnetic field lines in the region of the ground surface have a defined curvature and extend directionally along the subterranean cable strand. In other words, the field lines lie in axial planes of the cable strand.

As a consequence, a locating of the respective resonant circuit or transponders of the cable with a locating or reading system with detectors having corresponding detection coils or antennas and which is movable over the ground surface horizontal, can readily determine the orientation of the cable.

If the coil or antenna of such a locating or reading system or detector is rotated parallel to the cable strand orientation direction, the latter is indicated by a maximum in electromagnetic field strength generated by the resonant circuit or transponder.

As a consequence, the direction in which the cable strand runs is readily identified. In addition, a position determination is possible because the position of the cable strand can be readily ascertained by shifting the locating or reading system or detector perpendicularly to the cable axis. The depth of the cable strand is determined by a comparison of the field strength of the ferrite coils of the resonant circuit or transponder using the field strength detected by a second detector coil. In this connection, it is important to the present invention that the resonant circuit or transponder be directly on or in the cable strand so that not only will the identification be possible, but not especially effect determination of the position of the cable strand and thus the cable for optical communication can be possible.

The invention is based upon the fact that the signal transmissions in cables for optical communications are unaffected by electromagnetic influences like the electromagnetic fields which are detected in accordance with the invention.

The resonant circuits or transponders can be embedded in the inner wall of the outer wall of the jacket during the extrusion of the latter from synthetic resin and the formation of the cable. The resonant circuit or transponder is thus integrated directly in the cable jacket and is drawn with the cable, especially the glass fiber cable, into the protective conduit. The resonant circuits and transponders are no more damaged by the act of drawing the cable through the conduit then the jacketed optical waveguide.

According to a further feature of the invention, the ferrite coils of the resonant circuit or the transponder are axially spaced apart at predetermined distances in the lengths of cable or in their junction regions. Centering of the resonant circuits or transponders enables precise position determination of the cable strand in addition to the direction in which the strand runs. The inner sides of the resonant circuits and transponders and particularly their ferrite coils can be cylindrical, conical, differently conical or a similar geometric contours. With such configurations of the inner side of the coil, the field lines outside the ferrite coils and detectable at the earth surface will have a defined pattern, i.e. will extend in axial planes. The detection of the resonant circuits and transponders spaced apart in the cable strand is effected by measurement and following the direction of the strand.

The resonant circuits or transponders can be active or passive circuits which, for example, operate in a long wavelength range with a characteristic frequency below 150 kHz, preferably 135 kHz.

Generally the energy supply to the passive resonance circuits or transponders is electromagnetic energy radiated by the locating or reading system. Special significance can be transmitted for this purpose. In general, the locating or reading system is capable of launching electromagnetic energy to the cable which is received by the resonant circuits or transponders and is modified by them in a manner specific to the particular cable so that altered signals are emitted. The signals which are capable of modification serve simultaneously for energy delivery to the resonant circuit or transponder.

The signals can be continuously or periodically emitted.

Active resonant circuits or transponders have their own energy sources, for example, in the form of batteries. In the case of transponders, the energy storage serves in general to store data which is conduit and/or positioned specific. A transmission of this data is usually controlled by a microprocessor. The signals transmitted from the transponder can be of a continuous or periodic nature whereby directional data exchange is possible between the locating and reading system and the transponders.

A system in accordance with the invention can thus comprise:

a subterranean optical communication cable comprising at least one light waveguide and a cable jacket surrounding the light waveguide in the form of cable members and junction members joining the cable members together;

a detector movable over a surface of the ground above the cable; and

a plurality of electromagnetic field emitters selected from resonant circuits and transponders spaced apart on the cable and producing at the surface of the ground electromagnetic field lines of a defined curvature and extending in a direction in which the cable runs.

### BRIEF DESCRIPTION OF THE DRAWING

The above and other objects, features, and advantages will become more readily apparent from the following description, reference being made to the accompanying drawing in which:

FIG. 1 is a schematic illustration, in section, of a cable strand of glass fiber cable lengths with cable jackets and containing resonant circuits and illustrating the locating and reading device movable over the earths surface;

FIG. 2 is a plan view of the system of FIG. 1 in the region of a resonant circuit;

FIG. 3 is a sectional view of a portion of the substance of FIG. 1 showing the resonant circuit in the connection region between two lengths of cable;

FIG. 4 is a detail of the system of FIG. 1 of the cable in a protective conduit; and

FIGS. 5a, 5b and 5c show alternative configurations of the ferrite coil at its inner side.

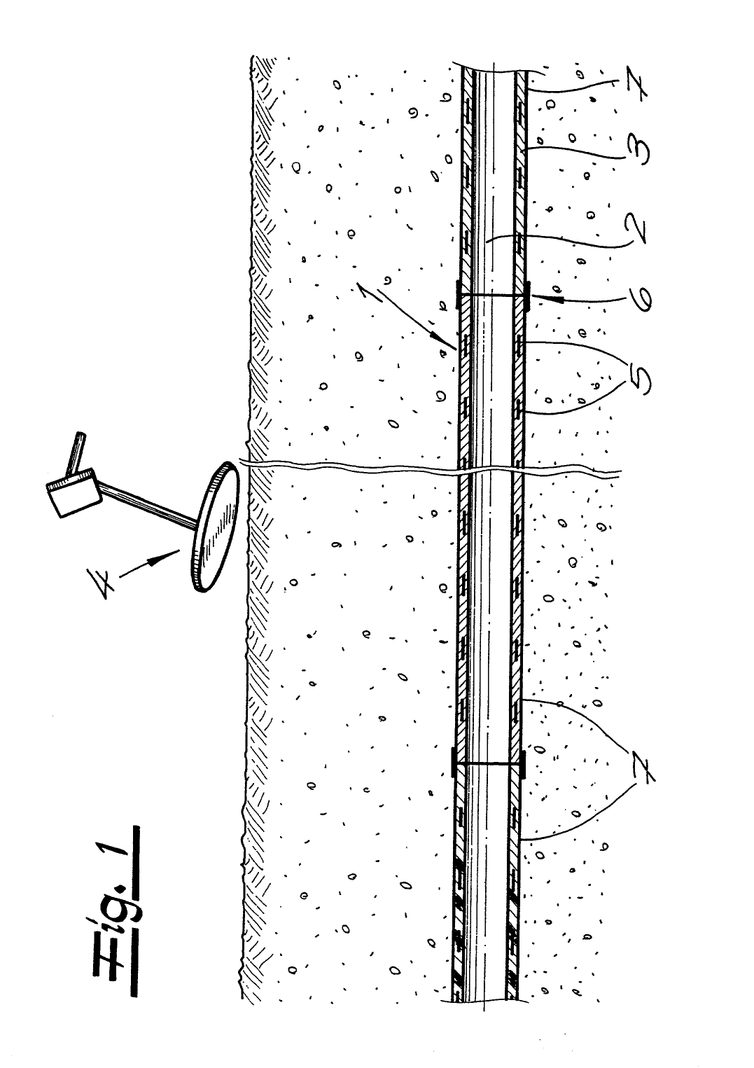

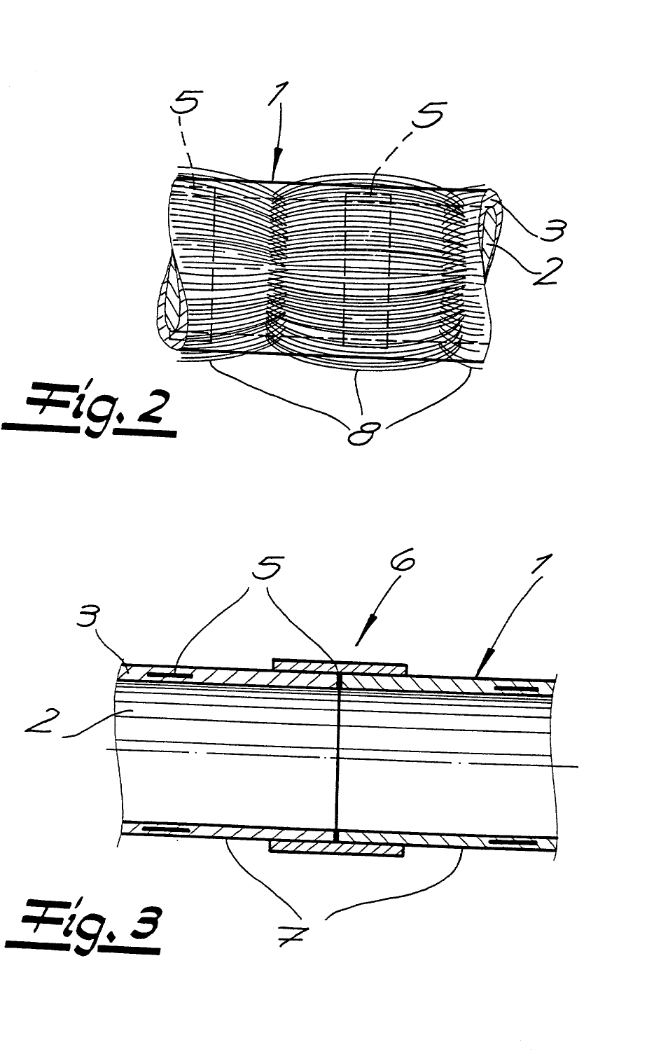

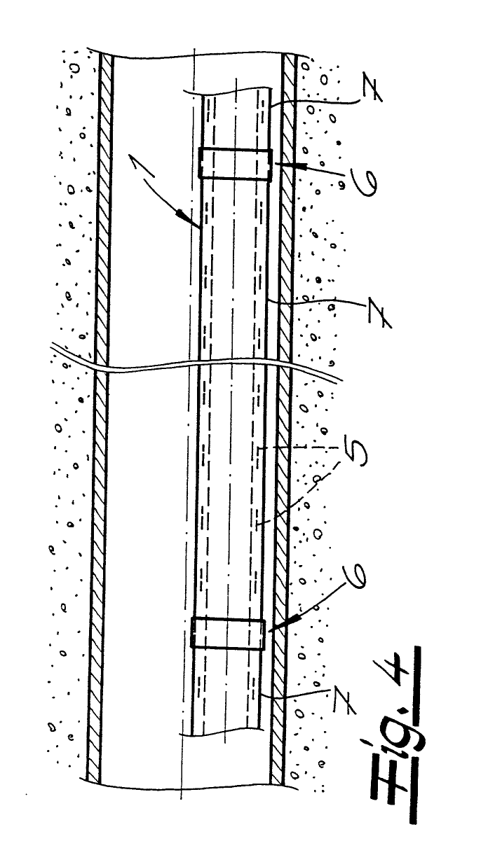

### SPECIFIC DESCRIPTION

In the drawing, a locator system has been shown for the identification and orientation of a subterranean cable 1 for optical communications. This cable 1 has one or more light waveguides 2, e.g. optical fibers, and a cable jacket 3 of, for example, a synthetic resin. The locating system comprises a location or reading device in the form of a detector 4 and resonant circuits 5 which are shown to be incorporated in the jacket 3. These resonant circuits 5 can be in or one the jacket 3 and/or in the junction regions 6 of the cable 1 which is formed from cable segments 7 joined end to end at the junctions 7.

The resonant circuits 5 are emitters and, as emitters, transponders can likewise be used.

The important point is that the emitters 5 have electromagnetic field lines 8 which have a defined curvature and lie in axial planes of the cable so that they run in the direction in which the cable runs and thus can, by their direction, indicate the cable direction. The resonant circuits 5 can be incorporated in the jacket 3 during the extrusion thereof and can be proximal to the inner or outer wall thereof. The resonant circuits 5 can include ferrite coils which are spaced apart in the axial direction with a predetermined spacing in the cable segments 7 or in the junction region 6 or both.

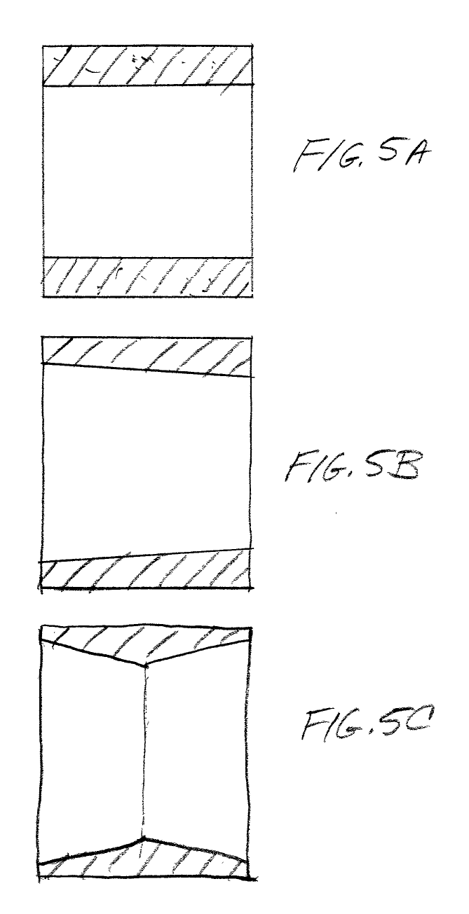

As shown in FIGS. 5a to 5c, the ferrite coils can have cylindrical, conical and/or different conical internal configurations. The ferrite coils can form passive resonant circuits receiving excitation from the detector 4.

I claim:

1. A cable locating and identification system comprising:
a subterranean optical communication cable comprising at least one light waveguide and a cable jacket surrounding said light waveguide in the form of cable members and junction members joining said cable members together;
a detector movable over a surface of the ground above said cable; and
a plurality of electromagnetic field emitters selected from resonant circuits and transponders spaced apart on said cable and producing at said surface of the ground electromagnetic field lines of a defined curvature and extending in a direction in which the cable runs.

2. The cable locating and identification system defined in claim 1 wherein said emitters are resonant circuits.

3. The cable locating and identification system defined in claim 1 wherein said emitters are transponders.

4. The cable locating and identification system defined in claim 1 wherein said emitters are located on said cable members.

5. The cable locating and identification system defined in claim 1 wherein said emitters are located on said junction members.

6. The cable locating and identification system defined in claim 1 wherein said emitters are integrated in said jacket along an inner or outer wall thereof.

7. The cable locating and identification system defined in claim 6 wherein said emitters include ferrite coils and are spaced apart on said cable with a predetermined spacing.

8. The cable locating and identification system defined in claim 7 wherein said emitters are embedded in said cable during extrusion thereof.

9. The cable locating and identification system defined in claim 8 wherein said ferrite coils have a substantially cylindrical internal geometry.

10. The cable locating and identification system defined in claim 8 wherein said ferrite coils have a substantially conical internal geometry.

11. The cable locating and identification system defined in claim 8 wherein said ferrite coils have a substantially doubly conical internal geometry.

12. The cable locating and identification system defined in claim 6 wherein said emitters are passive, receiving energization electromagnetically from said detector.

13. The cable locating and identification system defined in claim 6 wherein said emitters are active and include respective energization sources.
